(19) United States
(12) Patent Application Publication
(10) Pub. No.: US 2011/0256857 A1
(43) Pub. Date: Oct. 20, 2011

(54) Systems and Methods for Improving Antenna Isolation Using Signal Cancellation

(75) Inventors: Wei Chen, Newark, CA (US); Wilhelm Steffen Hahn, Los Altos, CA (US)

(73) Assignee: Intersil Americas Inc., Milpitas, CA (US)

(21) Appl. No.: 13/037,471

(22) Filed: Mar. 1, 2011

Related U.S. Application Data
(60) Provisional application No. 61/326,094, filed on Apr. 20, 2010.
(60) Provisional application No. 61/375,491, filed on Aug. 20, 2010.

(51) Int. Cl. H04B 15/00; H04W 4/00; H04B 3/36

(52) U.S. Cl. 455/422.1; 455/63.1; 455/7

(57) ABSTRACT

Interference compensation circuits can isolate a victim antenna from an aggressor antenna, which causes the antennas to appear as being spaced further apart. The interference compensation circuit can obtain samples of signals generated by a transmitter for transmission by the aggressor antenna and process the samples to generate an interference compensation signal. The generated interference compensation signal can be applied to a signal path between the victim antenna and a receiver to suppress, cancel, or otherwise compensate for interference imposed on the victim antenna by the signals transmitted from the aggressor antenna. The interference compensation signal is generated by adjusting at least one of amplitude, phase, and delay of the samples to emulate the interference imposed on the victim antenna.

### CROSS REFERENCE TO RELATED APPLICATIONS

This patent application claims to the benefit of U.S. Provisional Patent Application No. 61/326,094, entitled “System and Method for Improving Antenna Isolation Using Signal Cancellation” and filed Apr. 20, 2010. This application also claims to the benefit of U.S. Provisional Patent Application No. 61/375,491, entitled “Methods and Systems for Noise and Interference Cancellation” and filed Aug. 20, 2010. The entire contents of each of the foregoing priority applications are hereby fully incorporated herein by reference.

### BRIEF DESCRIPTION OF THE DRAWINGS

FIG. 1 is a functional block diagram of a communication system, in accordance with certain exemplary embodiments.

FIG. 2 is a functional block diagram of a communication system, in accordance with certain exemplary embodiments.

FIG. 3 is a functional block diagram depicting a transmit path for a transmitter, in accordance with certain exemplary embodiments.

FIG. 4 is a functional block diagram depicting a receive signal path for a receiver, in accordance with certain exemplary embodiments,

FIG. 5 is a functional block diagram depicting a communication system, in accordance with certain exemplary embodiments.

FIG. 6 is a functional block diagram depicting a communication system, in accordance with certain exemplary embodiments.

FIG. 7 is a functional block diagram depicting a dual band repeater, in accordance with certain exemplary embodiments.

FIG. 8 is a functional block diagram depicting a communication system, in accordance with certain exemplary embodiments.

FIG. 9 is a functional block diagram depicting a communication system, in accordance with certain exemplary embodiments.

FIG. 10 is a schematic diagram depicting a programmable M-bit delay element, in accordance with certain exemplary embodiments.

FIG. 11 is a schematic diagram depicting a programmable M-bit delay element, in accordance with certain exemplary embodiments.

FIG. 12 is a flow chart depicting a method for determining preferred delay compensation and canceller settings, in accordance with certain exemplary embodiments.

FIG. 13 is a block diagram depicting an interference compensation circuit that includes multiple noise cancellers, in accordance with certain exemplary embodiments.

FIG. 14 is a functional block diagram of a communication system, in accordance with certain exemplary embodiments.

Many aspects of the invention can be better understood with reference to the above drawings. The drawings illustrate only exemplary embodiments of the invention and are therefore not to be considered limiting of its scope, as the invention may admit to other equally effective embodiments. The elements and features shown in the drawings are not necessarily to scale, emphasis instead being placed upon clearly illustrating the principles of exemplary embodiments of the present invention. Additionally, certain dimensions may be exaggerated to help visually convey such principles. In the drawings, reference numerals designate like or corresponding, but not necessarily identical, elements.

### DETAILED DESCRIPTION OF EXEMPLARY EMBODIMENTS

The current invention is directed to systems and methods for improving signal isolation between two or more communication elements in a communication system. Exemplary embodiments described herein can support canceling, correcting, addressing, or compensating for interference, electromagnetic interference (“EMI”), noise, intermodulation products, or other unwanted spectral components associated with one or more communication paths in a communication system, such as data communication system in a wireless repeater. Compensating for interference can improve signal quality or enhance communication bandwidth or information carrying capability.

Exemplary embodiments of the present invention can be especially useful for improving signal isolation between two or more antennas that operate at frequencies within the same frequency band or within nearby frequency bands. For example, embodiments of the invention can be used to improve signal isolation between two antennas in a wireless repeater where two or more antennas transmit and receive signals having a frequency in the same frequency channel or frequency band.

The isolation between antennas operating in the same or nearby frequency channels can affect the amount of gain—and hence coverage—each transmitting device can provide. Embodiments described herein can compensate for leaking or other transmit signals that are introduced on a receive signal path of a first antenna by signals transmitted by a second antenna. This compensation provides improved antenna signal isolation. In a wireless repeater application, the antenna isolation provided by the present invention is used to increase constellation variance (CV), which results in increased data capacity for the wireless repeater.

Embodiments of the invention described herein can include a large signal compensation bandwidth. For example, the signal compensation bandwidth can cover substantially all available channels for a typical wireless repeater. To support large signal compensation bandwidths, certain exemplary embodiments include a large dynamic range with automatic signal compensation parameter adjustment and minimum insertion loss. These features can preserve transmit power and receiver sensitivity for the wireless repeater.

Certain exemplary embodiments can include a program, algorithm, or control logic for finding preferred, improved, or acceptable interference compensation settings in real-time or near real-time. The interference compensation settings can be found for multiple channels having different communication standards or protocols. The interference compensation settings can also be found for various antenna coupling conditions, temperature, power supply, transmit output power, receive sensitivity criteria, or other varying environmental conditions. These signal compensation settings can include in-phase values (I-values) and quadrature values (Q-values) for operating a noise canceller having an I/Q modulator or a separate I/Q modulator. Exemplary algorithms that may be implemented in certain exemplary embodiments described herein are discussed in U.S. patent application Ser. No. 13/014,681, entitled, “Methods and Systems for Noise and Interference Cancellation,” and filed on Jan. 26, 2011. The entire contents of U.S. patent application Ser. No. 13/014,681 are hereby fully incorporated herein by reference.

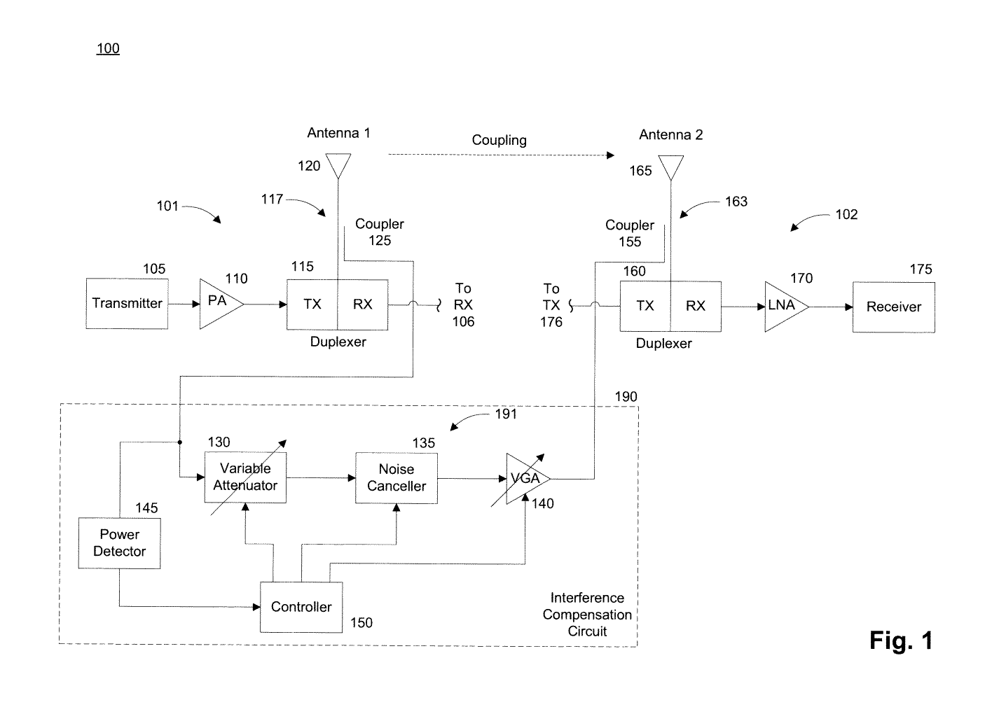

Turning now to the drawings, in which like numerals indicate like (but not necessarily identical) elements throughout the figures, exemplary embodiments of the invention are described in detail. FIG. 1 is a functional block diagram depicting a communication system 100, in accordance with certain exemplary embodiments. Referring to FIG. 1, the exemplary system 100 includes a first antenna 120 electrically coupled to a first transmitter 105 and to a first receiver 106 via a first duplexer 115. The first duplexer 115 isolates the first transmitter 105 from the first receiver 106 and enables the first transmitter 105 and the first receiver 106 to share the first antenna 120. The first transmitter 105 is electrically coupled to the first duplexer 115 via a transmit path 101 that includes a power amplifier 110.

The exemplary communication system 100 also includes a second antenna 165 electrically coupled to a second receiver 175 and a second transmitter 176 via a second duplexer 160. The second duplexer 160 isolates the second transmitter 176 from the second receiver 175 and enables the second transmitter 176 and the second receiver 175 to share the second antenna 165. The second receiver 175 is electrically coupled to the second duplexer 160 via a receive signal path 102 that includes a low noise amplifier 170.

The communication system 100 can be embodied in a wireless signal repeater, such as a cellular telephone repeater. For example, the system 100 may be embodied in a repeater for receiving and retransmitting Global System for Mobile Communications (GSM), Personal Communication Services (PCS), and/or Universal Mobile Telecommunications System (UMTS) signals. In certain wireless signal repeater embodiments, the first transmitter 105 and the first receiver 106 communicate with a base station, such as a wireless telephone antenna tower, via the first antenna 120 while the second transmitter 176 and the second receiver 175 communicate with a mobile station, such as a wireless telephone, via the second antenna 165. In such wireless signal repeater embodiments, the first transmitter can be thought of as an “uplink transmitter” and the first receiver 106 can be thought of as a “downlink receiver.” Similarly, the second transmitter 176 can be thought of as a “downlink transmitter” and the second receiver 175 can be thought of as an “uplink receiver.” In certain exemplary embodiments, communication paths of the transmitters 105, 176 and receivers 106, 175 are reversed such that the first transmitter 105 and the first receiver 106 communicate with a mobile station while the second transmitter 176 and the second receiver 175 communicate with a base station.

The exemplary communication system 100 also includes an interference compensation or canceling circuit 190 that protects the second receiver 175 from interfering signals imposed on the receive signal path 102 by signals transmitted by the first antenna 120. The interference compensation circuit 190 delivers an interference compensation signal into or onto the receive signal path 102 to cancel, suppress, mitigate, or otherwise compensate for the imposed interference. The interference compensation circuit 190 derives, produces, or generates the interference compensation signal by processing samples of aggressor communication signals that are propagating on the transmit path 101.

In the illustrated embodiment, an input of the interference compensation circuit 190 is electrically coupled to signal path 117 that connects the first antenna 120 to the first duplexer 115 via a coupler 125. The interference compensation circuit 190 also includes an output electrically coupled to a signal path 163 that connects the second antenna 165 to the second duplexer 160 via a coupler 155. The couplers 125, 155 can each include one or more capacitors, (e.g., sniffer or sampling capacitors), resistors, couplers, coils, transformers, signal traces, or transmission line components. In certain exemplary embodiments, one or both of the couplers 125, 155 are directional couplers. Using a directional coupler for coupler 155 can reduce the interference compensation signal being radiated by the receive antenna 165.

In this configuration, the interference compensation circuit 190 samples or receives a portion of the aggressor signal that is causing the interference and can compose the interference compensation signal for application to the victim receiver 175 that is impacted by the unwanted interference. That is, the interference compensation circuit 190 can sample the signals being transmitted by the first transmitter 105 and use the sampled signals to produce the interference compensation signal that is applied to the receive signal path 102 of the receiver 175 to provide cancellation, compensation, correction, or suppression of interference caused by the transmitted signal.

After sampling the transmitted signal, the interference compensation circuit 190 generates an interference compensation signal by adjusting in magnitude, phase, and or delay the sampled signals such that the interference compensation signal cancels at least a portion of the interference signal imposed on the second antenna 165 by signals transmitted by the first antenna 120. In certain exemplary embodiments, the sampled signal is processed so that it becomes approximately a negative or inverse of the interference signal incurred by the received victim signal on the receive signal path 102 of the receiver 175. The magnitude, phase, and delay adjustments are variable and can be controlled to improve interference compensation performance.

The exemplary interference compensation circuit 190 includes a variable attenuator 130, a noise canceller 135, and a variable gain amplifier (VGA) 140 disposed along a cancellation path 191. The cancellation path 191 extends from the coupler 125 where signals are sampled to the coupler 155 where interference compensation signals are applied to the receiver path 102. The interference compensation circuit 190 also includes a power detector 145 and a controller 150. The variable attenuator 130, which can include an active VGA or a passive attenuator, receives the sampled signals from the coupler 125. The variable attenuator 130 coarsely attenuates the sampled signal and passes the attenuated signal to the noise canceller 135. Having the attenuator 130 at the input of the noise canceller 135 can improve the dynamic range of the noise canceller 135. The attenuator 130 also optimizes the linearity of the cancellation path.

The exemplary noise canceller 135 adjusts the phase, amplitude, and/or delay of the sampled signal to derive, produce, or generate the interference compensation signal for application on the receive signal path 102. In certain exemplary embodiments, the noise canceller 135 includes an I/Q modulator that adjusts the phase, amplitude, and/or delay of the sampled signal based on an I-value and a Q-value. The I-value and Q-value can be received from the controller 150 as discussed below. In certain exemplary embodiments, the noise canceller 135 emulates the interference coupled from the first antenna 120 to the second antenna 165 using the sampled signal.

The output of the noise canceller 135 is electrically coupled to an input of the VGA 140. In certain exemplary embodiments, a passive attenuator is used in place of or in addition to the VGA 140. The VGA 140 (or passive attenuator) matches (e.g., coarsely) the interference compensation signal to the amplitude of the interference signal. In certain exemplary embodiments, the VGA 140 applies a gain that is constant across the frequency band of interest. The VGA 140 feeds the interference compensation signal to the coupler 155. In turn, the coupler 155 applies the interference compensation signal to the receive signal path 102 of the second receiver 175. In alternative exemplary embodiments, the VGA 140 is replaced with a passive attenuator. In certain exemplary embodiments, the gain of the VGA 140 (or passive attenuator) is adjusted to adapt to changes in the attenuation of the variable attenuator 130 and/or the magnitude of the coupling between the two antennas 120, 165, as well as the output power level of the power amplifier 110.

The VGA 140 (or passive attenuator) also allows for adjusting the output noise floor of the cancellation path at the coupler 155 in order to achieve high sensitivity for the second receiver 175. The variable attenuator 130 and the VGA 140 are each optional devices that can be omitted, for example for a noise canceller 135 having high linearity or if the attenuation in the cancellation path can compensate for the coupling between the antennas 120, 165. While FIG. 1 illustrates the components 130, 135, 140 of the interference compensation circuit 190 in a particular order, that order is exemplary and should not be considered as limiting. Moreover, the order of those components 130, 135, 140 is generally not critical and can be changed, or the components 130, 135, 140 can be rearranged, while maintaining acceptable performance of the interference compensation circuit 190 based on the criteria of the power amplifier 110 output power level and the sensitivity of the receiver 175.

The cancellation or compensation parameters of the interference compensation circuit 190 can be adjusted or controlled to improve the match of the interference compensation signal to the actual interference signal. In particular, the controller 150 of the interference compensation circuit 190 is capable of adjusting settings of each of the variable attenuator 130, the noise canceller 135, and the VGA 140 to improve interference compensation. For example, the controller 150 is capable of adjusting the gain of the variable attenuator 130 and the VGA 140. The controller 150 is also capable of adjusting the I-value and the Q-value of the noise canceller 135 to alter the amplitude, phase, and delay adjustments made by the noise canceller 135. The controller 150 is also capable of using an automatic gain control (AGC) method for optimizing or improving the settings of particularly the attenuator 130 and the VGA 140.

In certain exemplary embodiments, the controller 150 is communicably coupled to the optional power detector 145 for receiving a power measurement of the signal transmitted by the transmitter 105. In the illustrated embodiment, the input of the power detector 145 is connected to the cancellation path between the coupler 125 and the input of the variable attenuator 130 to measure the power level of the sampled signal. In alternative embodiments, the input of the power detector 145 is connected at or after the output of the variable attenuator 130. In another alternative embodiment, the input of the power detector 145 is connected to the output of the power amplifier 110. In yet another alternative embodiment, the controller 150 may be coupled to an existing power detector of the power amplifier 110. The power detector 145 can include an analog to digital (A/D) converter for converting a power measurement to a digital signal for input to the controller 150.

The controller 150 is implemented in the form of a processor, microprocessor, microcontroller, computer, state machine, programmable device, or other appropriate technology. The controller 150 executes one or more algorithms, computer programs, or software applications to adjust the settings of one or more of the variable attenuator 130, the noise canceller 135, and the VGA 140 based on a feedback value obtained from the receiver 175. In certain exemplary embodiments, this feedback value includes one or more of a Signal to Noise Ratio (SNR), a Receive Signal Strength Indicator (RSSI), a Carrier to Noise Ratio (C/N), a Repeater Amplifier Gain, a Packet Error Rate (PER), a Bit Error Rate (BER), and an Error Vector Magnitude. The polarity of the feedback would be positive (the higher the better) if SNR, C/N, or Repeater Amplifier Gain is used as the feedback value. The polarity of the feedback value would be negative (the lower the better) if any of the other aforementioned feedback values are used. The algorithms executed by the controller 150 can include one or more of a binary correction algorithm (BCA), a fast binary algorithm, (FBA), a minstep algorithm (MSA), a blind shot algorithm (BSA), a dual slope algorithm (DSA), and a track and search algorithm described in U.S. patent application Ser. No. 13/014,681.

In certain exemplary embodiments, the controller 150 uses the power measurement received from the power detector 145 or the feedback value received from the receiver 175 to adjust the gain of one or more of the components 130, 135, 140, as well as the phase and/or delay of the noise canceller 135. The controller 150 is also capable of adjusting the settings of one or more of the components 130, 135, 140 based on standards of the communication channel of the first transmitter 105 and/or the second receiver 175, antenna coupling conditions, temperature, power supply, as well as signal direction (e.g., uplink or downlink).

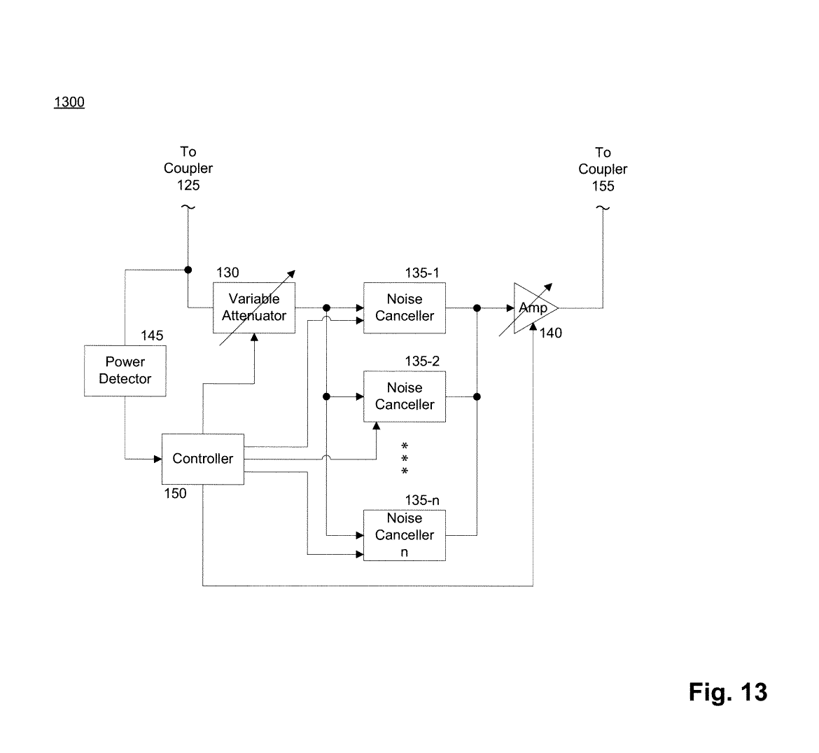

The interference compensation circuit 190 can include multiple noise cancellers 135 arranged in parallel to increase the interference compensation bandwidth. For example, FIG. 13 is a block diagram depicting an interference compensation circuit 1300 that includes multiple noise cancellers 135, in accordance with certain exemplary embodiments. Referring to FIG. 13, the exemplary interference compensation circuit 1300 includes any number “n” of noise cancellers 135-1-135-n arranged in parallel between the variable attenuator 130 and the VGA 140. In one example of a wireless telephone or cellular repeater embodiment, the noise cancellers 135-1-135-n are arranged in parallel to cover each of the PCS frequency band, the CDMA frequency band, and the UMTS frequency band. In one example, noise canceller 135-1 generates an interference compensation signal for interfering signals having a frequency in the PCS frequency band, noise canceller 135-2 generates an interference compensation signal for interfering signals having a frequency in the CDMA frequency band, and noise canceller 135-n generates an interference compensation signal for interfering signals having a frequency in the UMTS frequency band. In one example, a single noise canceller 135 may be used for each frequency band. In another example, multiple parallel noise cancellers 135 may be used for each frequency band. When multiple noise cancellers are arranged in parallel, for example to increase interference compensation bandwidth, one or more of the algorithms illustrated in FIGS. 29-31 of U.S. patent application Ser. No. 13/014,681 could be executed by the controller 150 to determine the preferred settings for each of the noise cancellers 135.

Referring back to FIG. 1, the variable attenuator 130, the VGA 140, and the power detector 145 each satisfy wide dynamic range constraints imposed by the power amplifier 110 output power and the receiver 175 sensitivity. For example, the output of a power amplifier for a cellular repeater may have a power level on the order of +33 dBm or more on the transmit path 101 where the coupler 125 samples the transmitted signal. The sensitivity of a receiver in a cellular repeater may be as low as −108 dBm.

In certain exemplary embodiments, all or a portion of the components 130-150 of the interference compensation circuit 190 can be embodied in a chip format as one or more integrated circuits (ICs) or as one or more hybrid circuits. In certain exemplary embodiments, the components 130-150 are embodied in multiple ICs. In certain alternative embodiments, the interference compensation circuit 190 includes discrete components mounted on or attached to a circuit board or similar substrate.

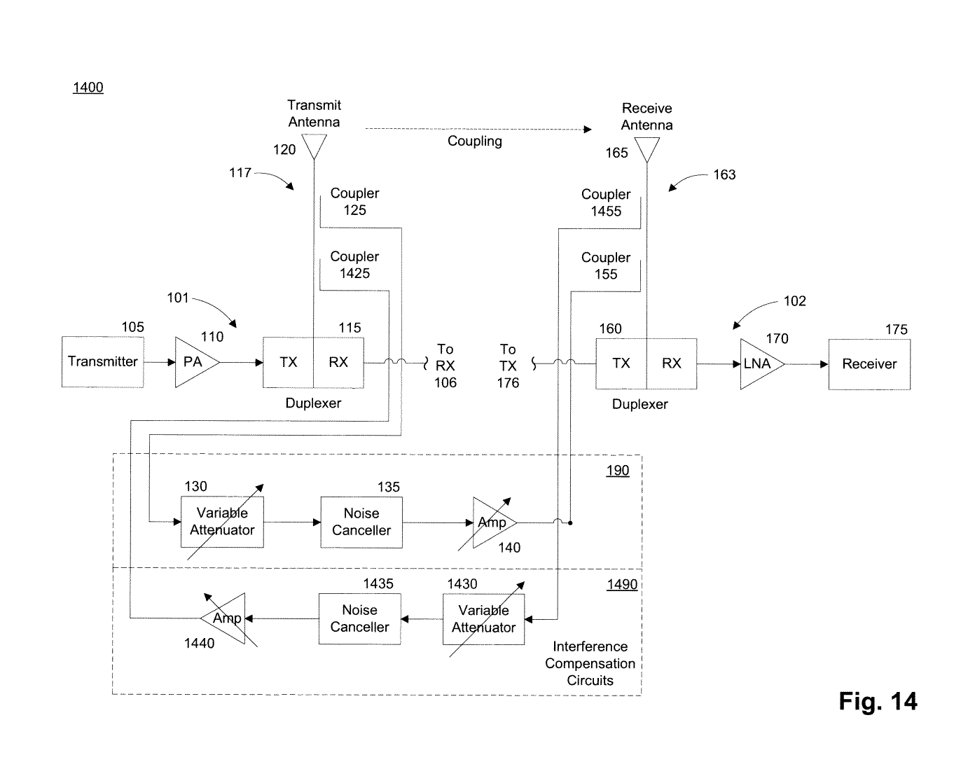

Similar antenna isolation improvement can be achieved for the protection of the first receiver 106 from interfering signals imposed on the first antenna 120 by signals transmitted by the second transmitter 176 via the second antenna 165. For example, FIG. 14 is a functional block diagram of a communication system 1400, in accordance with certain exemplary embodiments. Referring to FIG. 14, the exemplary communication system 1400 includes the interference compensation circuit 190 for compensating for interference imposed on the second antenna 165 by signals transmitted by the first transmitter 105 via the first antenna 120. The communication system 1400 also includes a second interference compensation circuit 1490 that is substantially the same as the interference compensation circuit 190. The interference compensation circuit 1490 includes a variable attenuator 1430, a noise canceller 1435, and a VGA 1440. The interference compensation circuit 1490 receives samples of signal transmitted by the second transmitter 176 via a coupler 1455 (or the coupler 155) and derives, generates, or produces an interference compensation signal based on the samples and applies the interference compensation signal onto or into a receive signal path of the first receiver 106 via a coupler 1425 (or the coupler 125). The controller 150 (or a second controller) can control the settings of the components 1430-1440 of the interference compensation circuit 1490, for example by executing one or more algorithms (e.g., FBA, BCA, MSA, BSA, DSA, or track and search) and obtaining feedback signals from the first receiver 106.

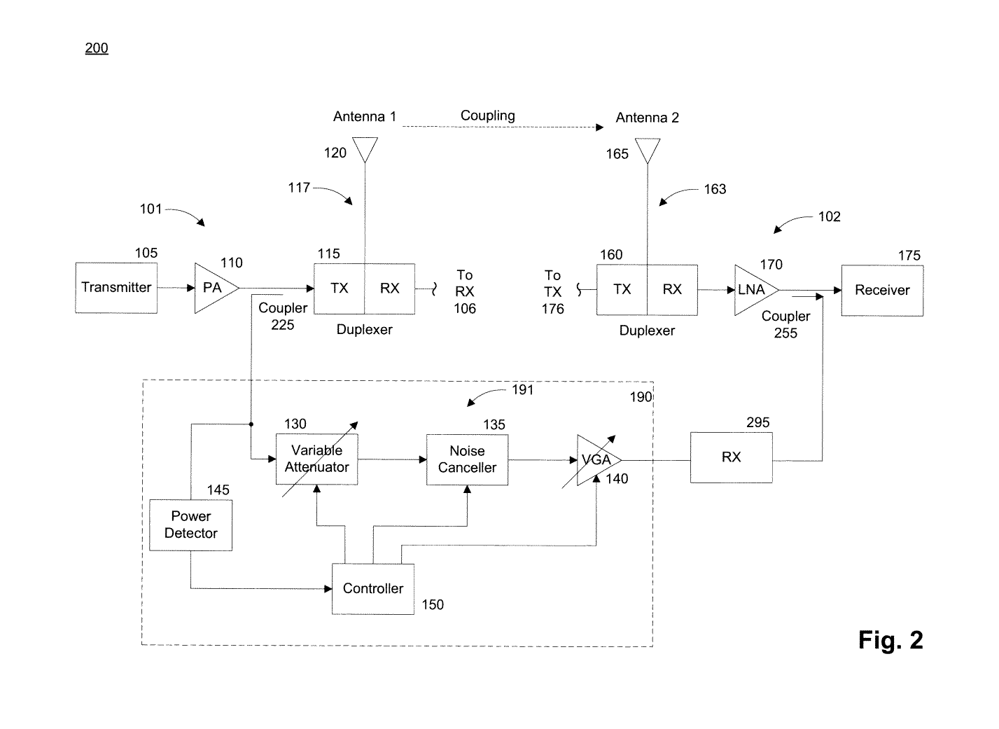

FIG. 2 is a functional block diagram depicting a communication system 200, in accordance with certain alternative exemplary embodiments. Referring to FIG. 2, the exemplary communication system 200 includes many of the same or similar components as the communication system 100 of FIG. 1. For example, the system 200 includes a first transmitter 105, a first receiver 106, a power amplifier 110, a first duplexer 115, a first antenna 120, a second transmitter 176, a second receiver 175, an LNA 170, and a second antenna 165. However, the communication system 200 differs from the communication system 100 of FIG. 100 in the placement of the interference compensation circuit 190 between the transmit path 101 and the receive signal path 102. In system 200, the interference compensation circuit 190 is coupled to the transmit path 101 between the power amplifier 110 and the first duplexer 115 via a coupler 225. Also, the cancellation point (i.e., the location of where the interference compensation signal is applied to the receive signal path 102) is positioned between the LNA 170 and the receiver 175 via coupler 255 in the exemplary communication system 200. In addition, the communication system 200 includes an optional receive filter 295 and/or an optional transmit filter for delay matching in order to maximize or improve the cancellation bandwidth. In the alternative embodiment of FIG. 1, a similar receive filter may be included in the duplexer 160. Similarly, a transmit filter may be included in the duplexer 115.

Although components 105 and 176 have been described and illustrated as transmitters, one or both of the components 105 and 176 may instead be a channel filter, a band filter, a mixer, a VGA, and/or a combination of these components having an input coupled to blocks 106 and 175, respectively. Likewise, the components 106 and 175 may instead be a channel filter, a band filter, a mixer, a VGA, and/or a combination of these components having an input coupled to blocks 105 and 176, respectively, in certain alternative embodiments.

One advantage of the exemplary embodiment of FIG. 2 is that any noise figure impact of inserting a directional coupler in the receive signal path 102 before the LNA 170 is reduced by positioning the coupler 255 at the output of the LNA 170. Another advantage is that insertion loss can be halved for both transmit path 101 and receive signal path 102 when implementing both uplink and downlink antenna isolation enhancement. However, the configuration of the exemplary communication system 100 of FIG. 1 has an advantage over the exemplary communication system 200 of FIG. 2 in that the communication system 100 provides a larger interference compensation bandwidth because group delays of both duplexers (115 and 160) do not appear in either the antenna coupling path or the cancellation path.

Hybrid communication systems combining aspects of both exemplary communication systems 100 and 200 are also feasible. For example, the signal transmitted by the transmitter 105 may be sampled at the output of the power amplifier 110 and the cancellation point may be positioned along the signal path 163 of the second antenna 165. Or, the signal transmitted by the transmitter 105 may be sampled along the signal path 117 of the first antenna 120 and the cancellation point may be positioned at the output of the LNA 170.

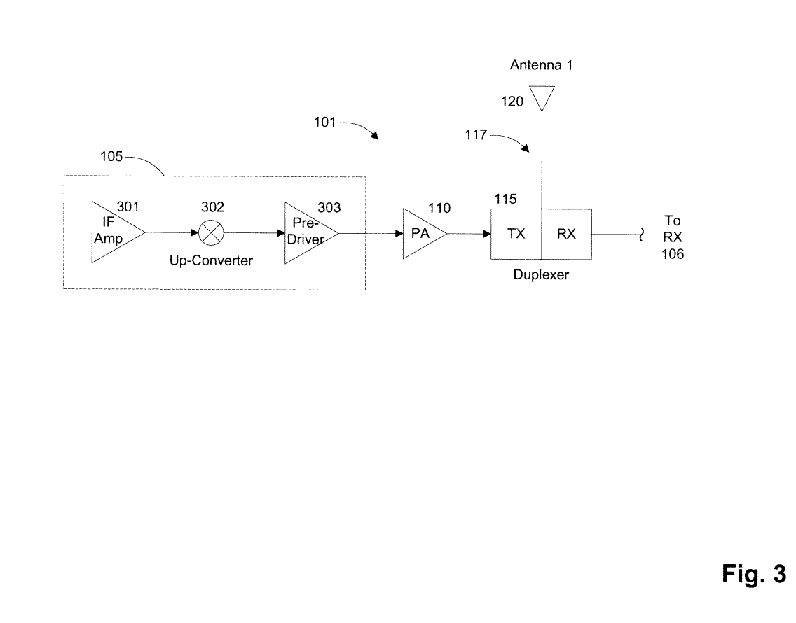

FIG. 3 is a functional block diagram depicting the transmit path 101 of FIGS. 1 and 2 in further detail, in accordance with certain exemplary embodiments. In particular, FIG. 3 depicts an intermediate frequency (IF) amplifier 301, an up-converter 302, and a pre-driver 303 upstream from the power amplifier 110 in the transmit path 101. This figure is provided to illustrate additional locations along the transmit path 101 where samples of a transmit signal used to generate an interference compensation signal may be obtained. For example, the samples may be obtained from the signal path 117 of the first antenna 120, at the output of the pre-driver 303, at the output of the IF amplifier 301, at the output of the power amplifier 110, or at the output of the up-converter 302.

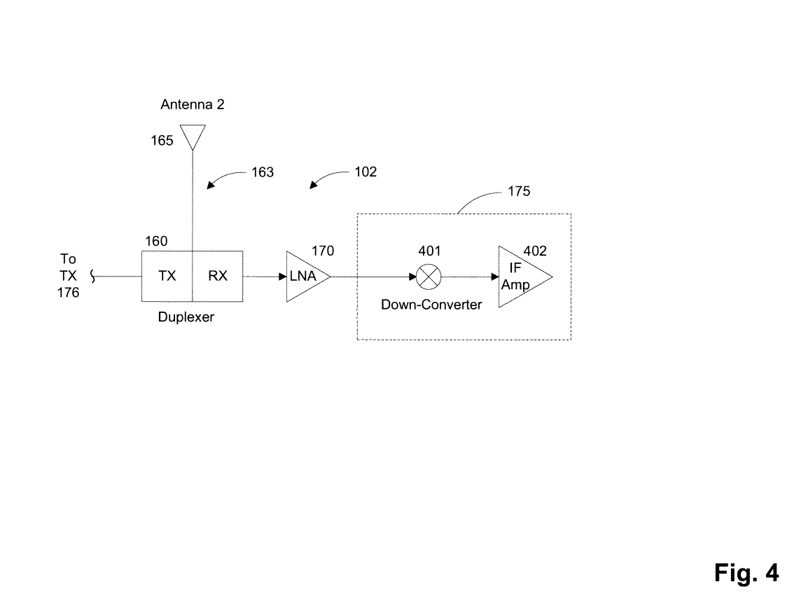

FIG. 4 is a functional block diagram depicting the receive signal path 102 of FIGS. 1 and 2 in further detail, in accordance with certain exemplary embodiments. In particular, FIG. 4 depicts a down converter 401 and an IF amplifier 402 in the receive signal path 102. This figure is provided to illustrate additional locations along the receive signal path 102 where an interference compensation signal may be applied. For example, the interference compensation signal may be applied along the signal path of the second antenna 165, at the output of the LNA 170, at the output of the down-converter 401, or at the input of the LNA 170.

Referring to FIGS. 3 and 4, any sampling point along the transmit path 101 can be combined with any cancellation point along the receive signal path 102 with appropriate matching group delays to maximize interference compensation bandwidth. Some combinations may include up/down frequency conversions to match to the same or a similar frequency range. For example, if the samples are obtained along the IF amplifier section of the transmit path 101, the interference compensation signal may be applied at the IF amplifier section of the receive signal path 102 without frequency conversion. If, in this example, the interference compensation signal is applied to a section of the receive signal path 102 at a different frequency than IF, then the samples and/or interference compensation signal may be frequency converted to match that different frequency.

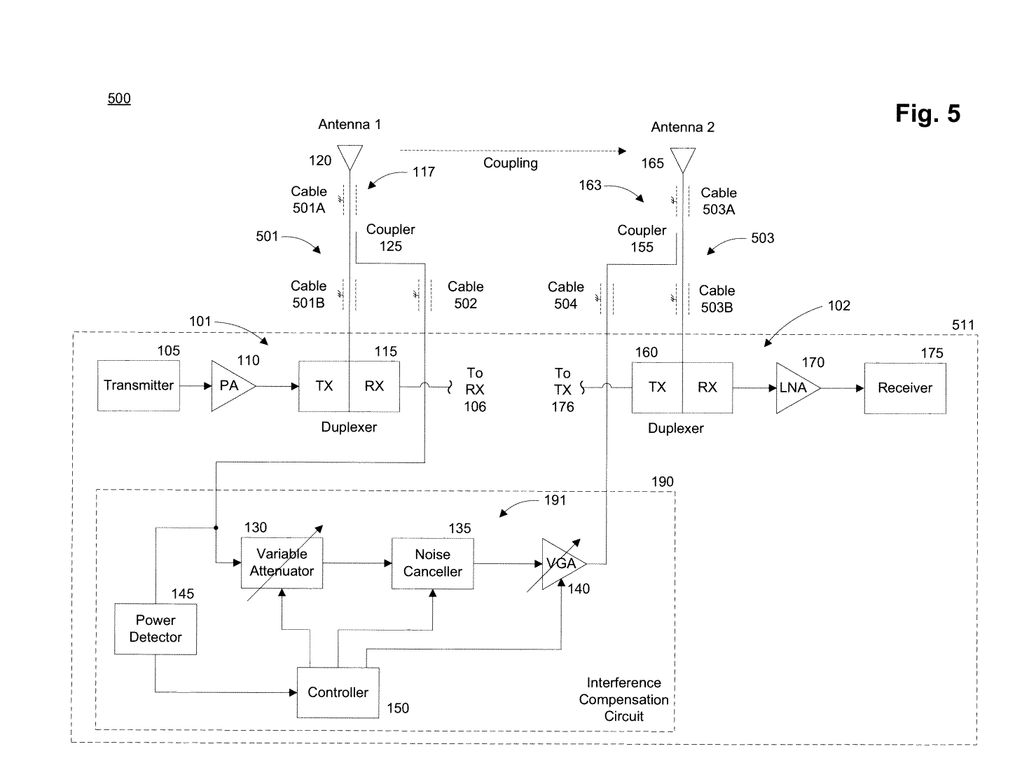

FIG. 5 is a functional block diagram depicting a communication system 500, in accordance with certain alternative exemplary embodiments. Referring to FIG. 5, the system 500 provides an alternative communication system 500 to that of FIGS. 1 and 2 where the antennas 120 and 165 are separated from each other by a distance. For example, in one exemplary embodiment, the antennas 120 and 165 are separated by a distance of approximately 100 feet. The separation of the two antennas 120 and 165 can cause a significant group delay of the coupling between the two antennas 120 and 165. To account for this group delay, the sampling point for sampling the signals transmitted by the transmitter 105 and the cancellation point where the interference compensation signal is applied to the receive signal path 102 can be arranged to match the group delay of the cancellation path 191 to that of the interference path (coupling path between antennas 120, 165).

FIG. 5 illustrates three exemplary methods for selecting the location of the sampling point and cancellation point. A first exemplary method employs an electrical cable 501 for connecting the first antenna 120 to the first duplexer 115 of a communication device 511, such as a cellular or wireless telephone repeater. In addition, an electrical cable 503 connects the second antenna 165 to the second duplexer 160 of the device 511. In this exemplary method, the cable 501 is divided into two sections 501A and 501B and the cable 503 is divided into two sections 503A and 503B. Coupler 125 is disposed between the two sections 501A and 501B of cable 501 to define the location of the sampling point. Similarly, the coupler 155 is disposed between the two sections 503A and 503B to define the location of the cancellation point. In addition, an electrical cable 502 connects the coupler 125 to interference compensation circuit 190 and an electrical cable 504 connects the coupler 155 to the interference compensation circuit 190. In this configuration, the lengths of the cables 502 and 504 can be selected such that the total delay caused by the cables 502 and 504 and the interference compensation circuit 190 matches or approximately matches the total delay caused by the antenna coupling, the cable 501A, and the cable 503A.

A second exemplary method for selecting the location of the sampling point and the cancellation point provided in FIG. 5 involves omitting cable section 501B, cable 502, and cable section 503A, while keeping cable 504 and cable sections 501A and 503B. In this exemplary embodiment, the length of cable section 501A can be relatively short, while the lengths of cable 504 and the cable section 503B are relatively long. In this way, the total delay caused by the cable 504 and the interference compensation circuit 190 matches or approximately matches the total delay of the antenna coupling and the cable section 501A.

A third exemplary method for selecting the location of the sampling point and the cancellation point provided in FIG. 5 involves omitting cable sections 501A and 503B and cable 504, while keeping cable sections 501B, 503A, and cable 502. In this exemplary embodiment, the length of cable section 503A can be relatively short, while the lengths of the cable 502 and the cable section 501B are relatively long. In this way, the total delay caused by the cable 502 and the interference circuit 190 matches or approximately matches the total delay of the antenna coupling and cable section 503A.

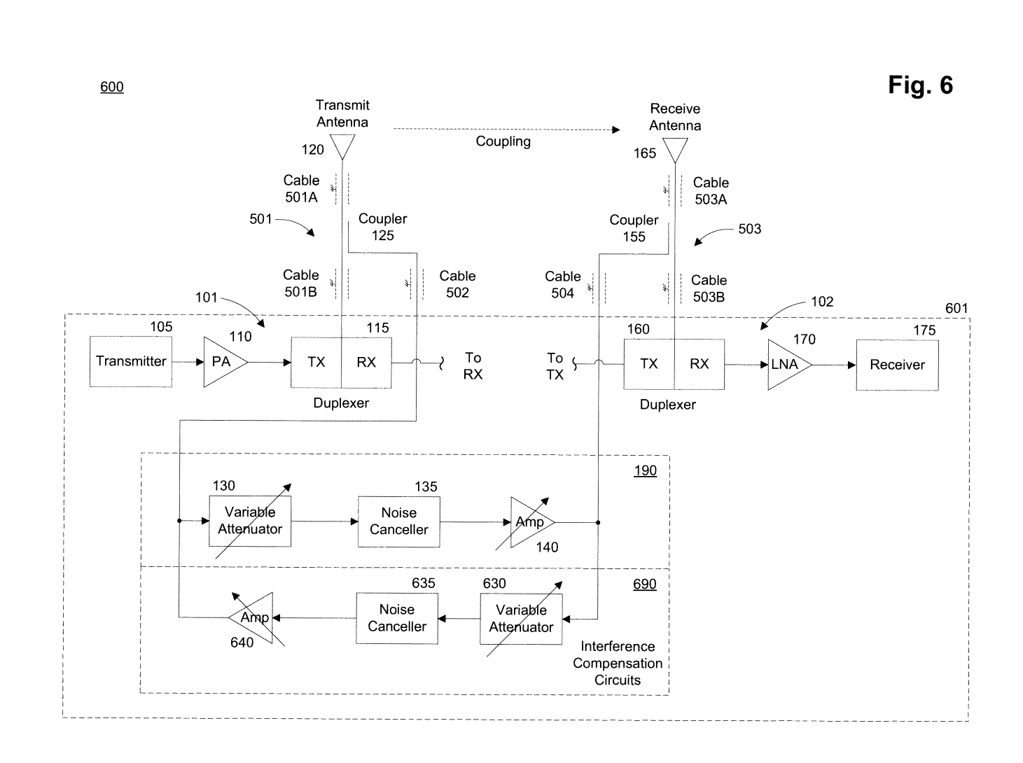

FIG. 6 is a functional block diagram depicting a communication system 600, in accordance with certain alternative exemplary embodiments. The system 600 provides an alternative communication system 600 to that of the exemplary communication system 500 of FIG. 5. In the exemplary embodiment of FIG. 6, a communication device 601 includes two interference compensation circuits 190, 690 for protecting antennas 120, 165 from interfering signals, respectively. The two interference compensation circuits 190, 690 share the same set of couplers 125, 155. For example, this exemplary configuration may be used when the two antennas 120,165 are positioned at significant distances from each other such that the attenuation provided by each interference compensation circuit 190, 690 during normal operation is large enough to prevent the loop formed by the interference compensation circuits 190, 690 from entering oscillation under practical circumstances.

As the frequency of wireless telephone communications can be located in different frequency bands, there is a need for repeaters that accommodate different frequency bands, such as CDMA/GSM 800/900 bands and PCS/WCDMA 1800/2100 bands. The benefit of such an arrangement is that the repeater could boost signals in different frequency bands at different times, for example by switching for band selection, or simultaneously. The antenna isolation methods and systems discussed above could be applied to dual band repeaters as well as single band repeaters.

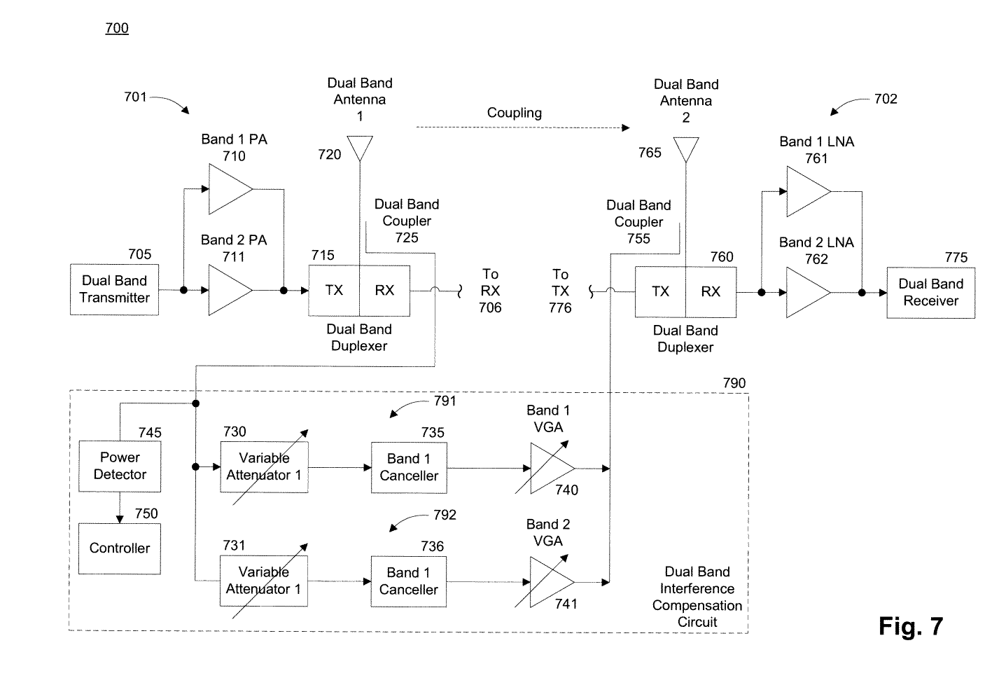

FIG. 7 is a functional block diagram depicting a dual band repeater 700, in accordance with certain exemplary embodiments. Referring to FIG. 7, the exemplary dual band repeater 700 includes a first dual band antenna 720 electrically coupled to a first dual band transmitter 705 and to a first dual band receiver 706 via a first dual band duplexer 715. The first dual band duplexer 715 isolates the first dual band transmitter 705 from the first dual band receiver 706 and enables the first dual band transmitter 705 and the first dual band receiver 706 to share the first dual band antenna 720.

The exemplary dual band repeater 700 also includes a second dual band antenna 765 electrically coupled to a second dual band transmitter 776 and to a second dual band receiver 775 via a second dual band duplexer 760. The second dual band duplexer 760 isolates the second dual band transmitter 776 from the second dual band receiver 775 and enables the second dual band transmitter 776 and the second dual band receiver 775 to share the second dual band antenna 765.

The first dual band transmitter 705 is electrically coupled to the first dual band duplexer 715 via a transmit path 701 that includes two parallel power amplifiers 710, 711. The power amplifier 710 adjusts the intensity of signals transmitted by the transmitter 705 in a first of the dual bands and the power amplifier 711 adjusts the intensity of signals transmitted by the transmitter 705 in a second of the dual bands.

The second dual band receiver 775 is electrically coupled to the second dual band duplexer 760 via a receive signal path 702 that includes two parallel LNAs 761, 762. The LNA 761 adjusts the intensity of signals received by the second antenna 765 in the first of the dual bands and the LNA 762 adjusts the intensity of signals received by the second antenna 765 in the seconds of the dual bands.

The exemplary dual band repeater 700 also includes a dual band interference compensation circuit 790. The exemplary dual band interference compensation circuit 790 obtains samples of signals transmitted by the transmitter 705 via a dual band coupler 725 similar to or the same as the coupler 125 of FIG. 1. The dual band interference compensation circuit 790 includes two interference compensation paths 791, 792, one for each of the dual bands. The interference compensation path 791 includes a variable attenuator 730, a noise canceller 735, and a VGA 740 that are similar to or the same as the variable attenuator 130, the noise canceller 135, and the VGA 140 of FIG. 1, respectively. The components 730, 735, 740 of the interference compensation path 791 derives, generates, or produces an interference compensation signal that cancels, suppresses, mitigates, or otherwise compensates for interference imposed on the second dual band receiver 775 by signals transmitted by the first dual band transmitter 705 in the first of the dual bands. The components 730, 735, 740 of the first interference compensation path 791 derives, generates, or produces the interference compensation signal by adjusting at least one of phase, amplitude, and delay of sampled transmit signals obtained via the coupler 725 and delivers the interference compensation signal onto or into the receiver path 702 via a coupler 755, which is similar to or substantially the same as coupler 155 of FIG. 1.

Similarly, the interference compensation path 792 includes a variable attenuator 731, a noise canceller 736, and a VGA 741 that are similar to or the same as the variable attenuator 130, the noise canceller 135, and the VGA 140 of FIG. 1, respectively. The components 731, 736, 741 of the interference compensation path 792 derives, generates, or produces an interference compensation signal that cancels, suppresses, mitigates, or otherwise compensates for interference imposed on the second dual band receiver 775 by signals transmitted by the first dual band transmitter 705 in the second of the dual bands. The components 731, 736, 741 of the first interference compensation path 791 derives, generates, or produces the interference compensation signal by adjusting at least one of phase, amplitude, and delay of sampled transmit signals obtained via the coupler 725 and delivers the interference compensation signal onto or into the receiver path 702 via the coupler 755.

In certain exemplary embodiments, the settings of the components 730-741 of the interference compensation circuit 790 are adjusted by a controller 750 that is similar to or substantially the same as the controller 150 of FIG. 1. In addition, the controller 750 is capable of adjusting the settings of the components 730-741 based on a power measurement receiver from a power detector 745.

In certain exemplary embodiments, one or more of the VGAs 740, 741 and/or variable attenuator 730, 731 is frequency selective. In certain exemplary embodiments, one or more of the noise cancellers 735, 736 are frequency selective. For example, an LC tank and/or input matching may be employed for frequency selectivity. This frequency selectivity increases the rejection of the other band (than the one the interference compensation path is intended) for the purpose of out-of-band interference rejection and oscillation suppression. This is especially beneficial for implementations in which the repeater 700 has both bands active simultaneously.

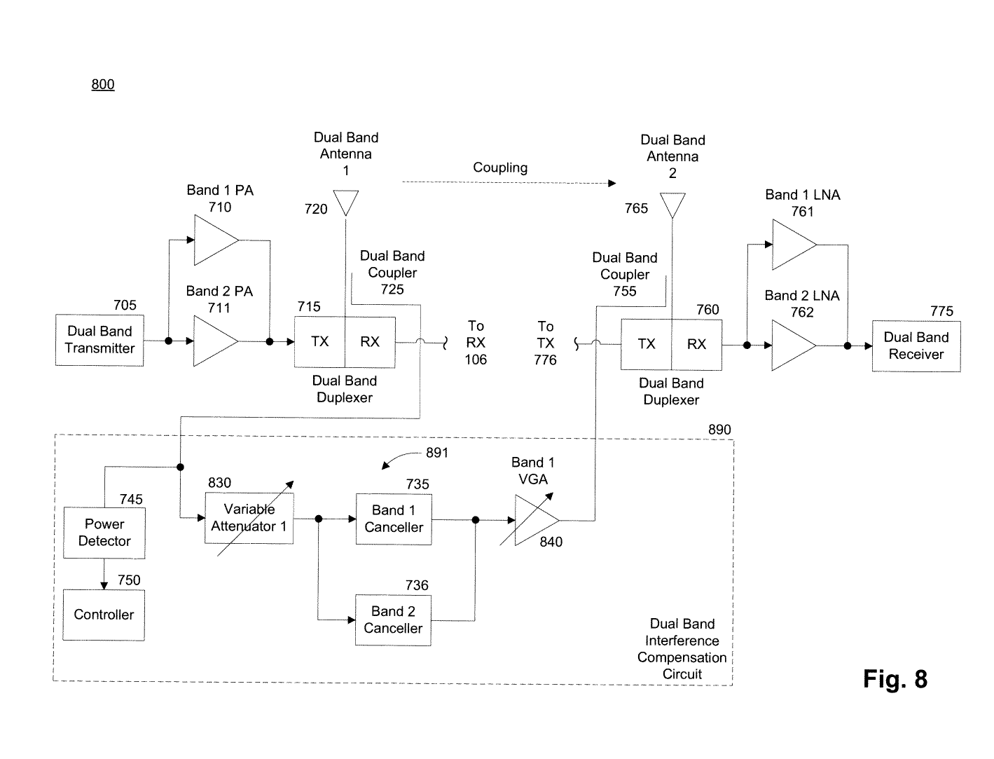

FIG. 8 is a functional block diagram depicting a dual band repeater 800, in accordance with certain alternative exemplary embodiments. Referring to FIG. 8, the dual band repeater is an alternative to that of the dual band repeater 700 of FIG. 7. In particular, the dual band repeater 800 includes a dual band interference compensation circuit 890 that includes a single interference compensation path 891 rather than two interference compensation paths 791, 792. The exemplary interference compensation path 891 includes two noise cancellers 735, 736 in parallel and disposed between a single variable attenuator 830 and a single VGA 840. The noise canceller 735 is used in the generation of an interference compensation signal for the first of the dual bands and the noise canceller 736 is used in the generation of an interference compensation signal for the second of the dual bands. An advantage of the dual band interference compensation circuit 890 includes a reduction in materials (e.g., one less variable attenuator, one less VGA, and associated hardware). Another advantage of the dual band interference compensation circuit 890 includes a savings in space. For example, in certain exemplary embodiments, the dual band interference compensation circuit 890 is built on an integrated circuit or a module where available space may be limited.

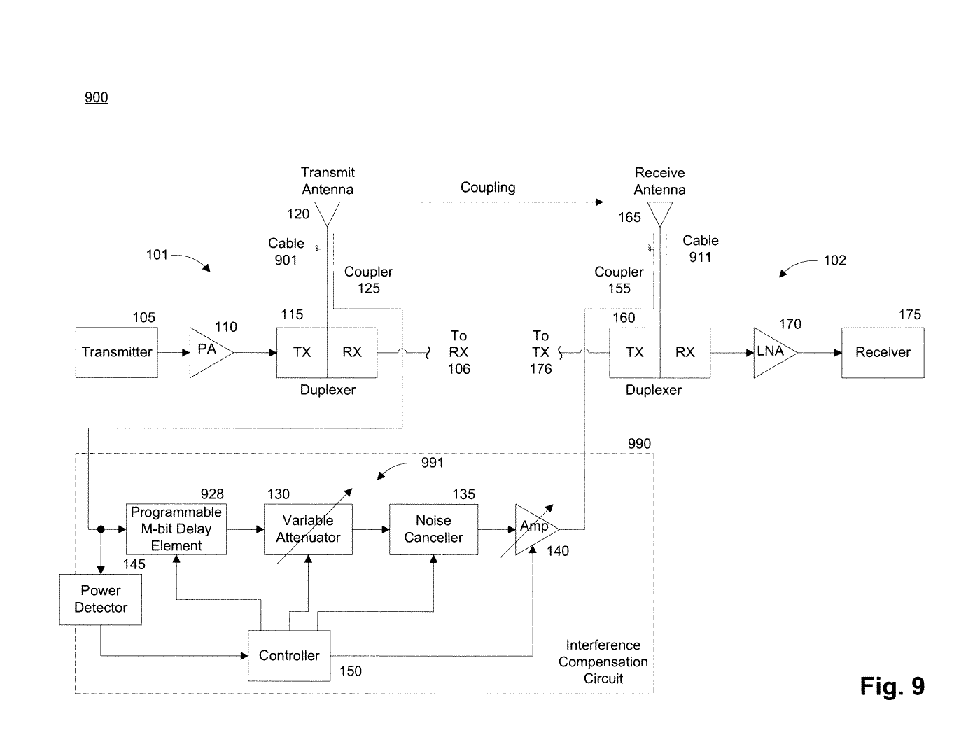

FIG. 9 is a functional block diagram depicting a communication system 900, in accordance with certain alternative exemplary embodiments. In particular, the communication system 900 is an alternative to the communication system 500 that employs delay compensation. The exemplary communication system 900 includes an interference compensation circuit 990 that includes a programmable M-bit delay element 928. The programmable M-bit delay element 928 compensates for delay caused by cable 901 and cable 911, as well as delay caused by coupling between the two antennas 120, 165.

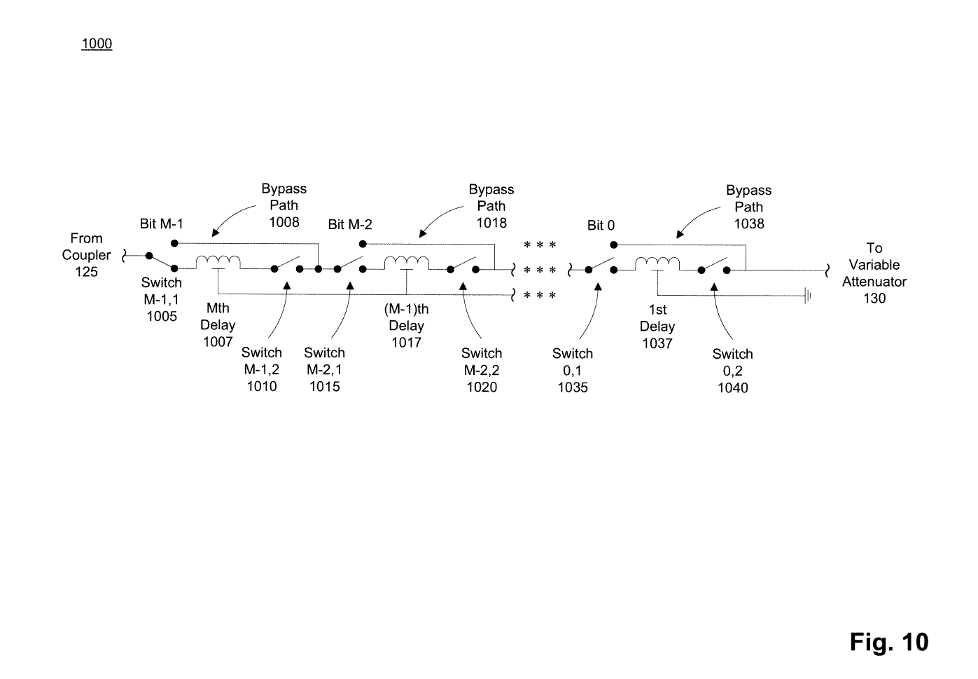

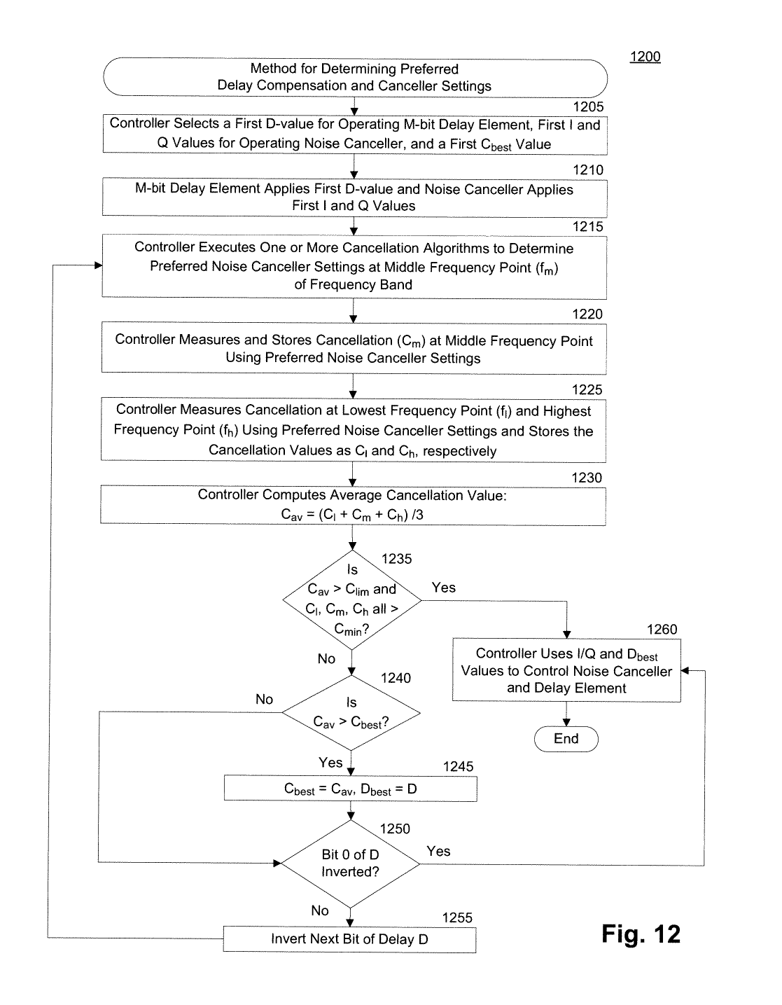

Although the programmable M-bit delay element 928 is illustrated between the coupler 125 and the variable attenuator 130, the programmable M-bit delay element 928 may be positioned between the variable attenuator 130 and the noise canceller 135, between the noise canceller 135 and the VGA 140, or between the VGA 140 and the coupler 155. In addition, in certain alternative embodiments, the variable attenuator 130 may be omitted as the M-bit delay element 928 may provide sufficient attenuation. With selection of an appropriate delay based on an algorithm, such as method 1200 illustrated in FIG. 12 and discussed below, the interference compensation bandwidth offered by the interference compensation circuit 990 may be increased. Exemplary M-bit delay elements that can be used in the communication system 900 are described below in connection with FIGS. 10-12.

FIG. 10 is a schematic diagram depicting a programmable M-bit delay element 1000, in accordance with certain exemplary embodiments. Referring to FIG. 10, the exemplary M-bit delay element 1000 includes a number ‘M’ of delay elements. In particular, the M-bit delay element 1000 includes a series of delay elements starting with a first delay element 1037 and ending with an M−1 delay element 1017 and an Mth delay element 1007. In certain exemplary embodiments, these delay elements 1007, 1017, . . . , 1037 are binary based. In one example, the delay of the first delay element 1037 has a unit length of delay while the pth delay element would have a delay of 2^{(p-1)} times the unit delay, with p being in the range of 2 to M−1. In certain exemplary embodiments, the delay elements 1007, 1017, . . . , 1037 have any other form known to those of ordinary skill in the art having the benefit of the present disclosure with which the combination of delay elements 1007, 1017, . . . , 1037 covers the delay matching necessary for isolation improvement of two antennas 120, 165. In one example, the Mth delay element 1007 could have a value that matches the delay given by the cable 901 and 911 (e.g., 50 ns for 50 feet of cable length) while the remainder of the delay elements 1017, . . . , 1037 are binary based to compensate the delay given by the separation of the two antennas 120, 165. This is beneficial in implementations in which the antenna separation is variable depending on how the communication system 900 is installed.

To program the delay elements 1007, 1017, . . . , 1037, M switch pairs 1005/1010, 1015/1020, . . . , and 1035/1040 are included for the Mth delay element 1007, the M−1 delay element 1017, . . . , and the first delay element 1037, respectively. The M-bit programmable delay element 1000 also includes bypass paths 1008, 1018, . . . , 1038 in parallel with the delay elements 1007, 1017, . . . , 1037. Each switch pair 1005/1010, 1015/1020, . . . , 1035/1040 includes a single pole double throw switch and a single pole single throw switch. For example, switch (M−1, 1) 1005 is a single pole double throw switch and switch (M−1, 2) is a single pole single throw switch. Proper termination of switches and strip lines connecting the switches can aid in achieving low insertion loss.

In one example, to include the Mth delay element 1007 in the interference compensation path 991, the switch 1005 is positioned to connect the coupler 125 to the Mth delay element 1007 and switch 1010 is activated to connect switch 1010 to the switch 1015 of the next delay element 1017. In another example, to bypass the Mth delay element 1007, the switch 1005 is positioned to connect the coupler 125 to the bypass path 1008, while the switch 1010 is deactivated to remove the impact of the delay element 1007.

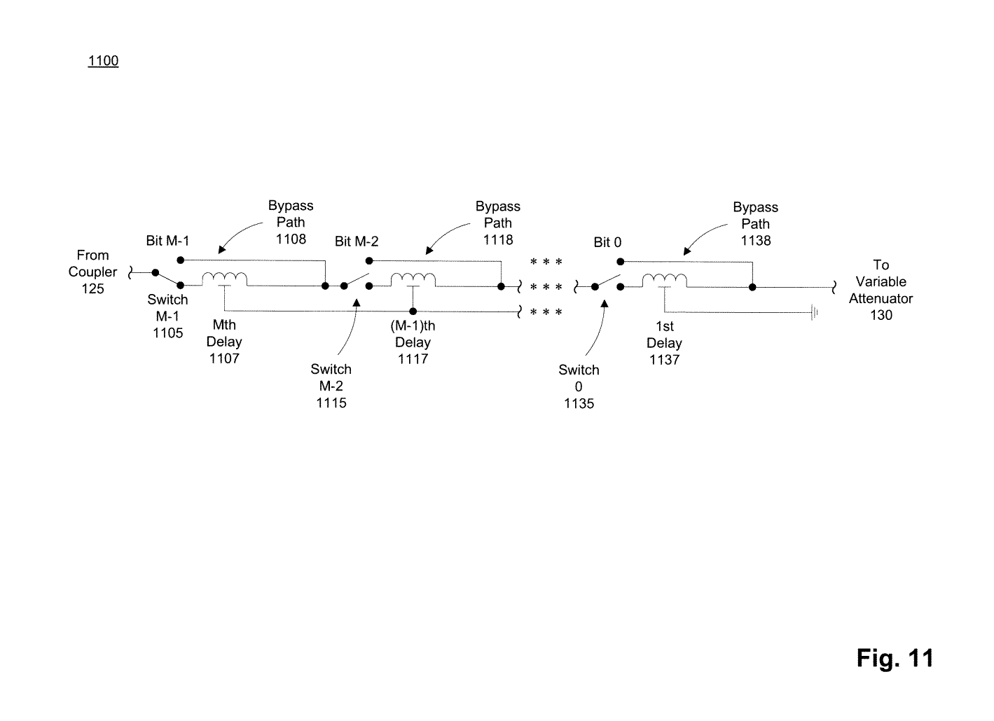

FIG. 11 is a schematic diagram depicting a programmable M-bit delay element 1100, in accordance with certain alternative exemplary embodiments. Referring to FIG. 11, the exemplary M-bit delay element 1100 includes a series of delay elements starting with a first delay element 1137 and ending with an M−1 delay element 1117 and an Mth delay element 1107. The M-bit delay element 1100 also includes bypass paths 1108, 1118, . . . , 1138 in parallel with the delay elements 1107, 1117, . . . , 1137. However, each delay element 1107, 1117, . . . , 1137 includes a single pole double throw switch 1105, 1115, . . . , 1135, respectively, rather than two switches as included in the M-bit delay element 1000 of FIG. 10. As illustrated in FIG. 11, each delay element 1107, 1117, . . . , 1137 is connected to its respective bypass path 1108, 1118, . . . , 1138 and next stage switch 1115, . . . , 1135, and the variable attenuator 130 (if coupled to the M-bit delay element 1100). One advantage of the M-bit delay element 1100 over the M-bit delay element 1000 is a reduction in the amount of materials required.

FIG. 12 is a flow chart depicting a method 1200 for determining preferred delay compensation and canceller settings, in accordance with certain exemplary embodiments. As discussed below, the preferred delay is determined using one or more algorithms or computer programs similar to those used in a noise cancellation application, such as an FBA, BCA, MSA, BSA, DSA, or track and search algorithm. The feedback value for the algorithms or computer programs can be the average cancellation across the frequency band of interest. Referring to FIGS. 9-12, in block 1205, the controller 150 selects a first D-value (which represents a delay D) for operating the M-bit delay element 928, a first I-value and a first Q-value for operating the noise canceller 135, and a first C_{best} value (e.g. C_{best}=0) for comparison in block 1240. In certain exemplary embodiments, the first or start values are typically values found in a prior execution of the method 1200 or another algorithm for determining preferred delay compensation and canceller settings. The controller 150 communicates the first D-value to the M-bit delay element 928 and the first I-value and Q-value to the noise canceller 135.

In block 1210, the M-bit delay element 928 applies the first D-value to the switches and the noise canceller 135 applies the first I-value and first Q-value. In one example, the first D-value is D=(10 . . . 0). The controller 150 also sets D_{best} to the first D-value.

In block 1215, the controller 150 executes one or more iterations of a cancellation algorithm (e.g., FBA, BCA, MSA, BSA, DSA, or track and search) to determine preferred settings for operating noise canceller 135. During the execution of the one or more algorithms, the second receiver 175 provides a feedback value to the controller 150, such as a SNR, a RSSI, a C/N, a Repeater Amplifier Gain, a PER, a BER, and/or an Error Vector Magnitude. In certain exemplary embodiments, the feedback value is measured at the middle frequency point fₘ of the interested frequency band or channels. For example, the middle frequency is 2140 MHz for a UMTS frequency band from 2110 MHz to 2170 MHz. The controller 150 uses this feedback value to search for a preferred cancellation point such that the feedback value is preferred, improved, or acceptable. For example, the polarity of the feedback value would be positive (the higher the better) if Repeater Amplifier Gain, RSSI, C/N, or SNR is used for the feedback value, or the polarity of the feedback value would be negative (the lower the better) if any of the other aforementioned feedback values is employed.

In block 1220, the controller 150 computes an amount of cancellation “Cₘ” by taking the difference between the feedback value at the preferred cancellation point and the feedback value when the noise canceller 135 is turned off. The controller 150 stores the cancellation amount Cₘ.

In block 1225, with the same I-value, Q-value, and D-value that resulted in the preferred cancellation point, the controller 150 commands the second receiver 175 to provide a feedback value for the lowest and highest frequency points fₗ and fₕ, respectively, for the frequency band while the transmitter 105 transmits signals at their corresponding frequencies. This implies that either the repeater has traffic at within this frequency band or needs to generate pilot tones. The controller 150 calculates cancellation value Cₗ by taking the difference between the feedback value at the lowest frequency point fₗ (e.g., 2110 MHz) with the noise canceller 135 operating at the preferred cancellation point and the feedback value with the noise canceller 135 turned off. Similarly, the controller 150 calculates cancellation value Cₕ by taking the difference between the feedback value at the highest frequency point fₕ (e.g., 2170 MHz) with the noise canceller 135 operating at the preferred cancellation point and the feedback value with the noise canceller 135 turned off. The controller 150 stores Cₗ and Cₕ. In block 1230, the controller 150 computes the average cancellation value, “Cₐᵥ” as: Cₐᵥ=(Cₗ+Cₘ+Cₕ)/3.

In block 1235, the controller 150 conducts an inquiry to determine whether the average cancellation value Cₐᵥ is greater than a predetermined threshold value, “Cₗᵢₘ”. The controller 150 also conducts an inquiry to determine whether each of Cₗ, Cₘ, and Cₕ are greater than a predetermined threshold value, “Cₘᵢₙ.” If Cₐᵥ is greater than Cₗᵢₘ and each of Cₗ, Cₘ, and Cₕ are greater than Cₘᵢₙ, then the method 1200 follows the “Yes” branch to block 1260. Otherwise, the method 1200 follows the “No” branch to block 1240.

In block 1260, the controller 150 operates the noise canceller 135 and the M-bit delay element 928 using the I-value, Q-value, and D_{best} value that resulted in the cancellation values exceeding the thresholds. The controller 150 communicates the I-value and Q-value to the noise canceller 135 and the noise canceller 135, in turn, applies the I-value and Q-value to an I/Q modulator of the noise canceller 135 to generate the interference compensation signal. The controller 150 also communicates the D_{best} value to the M-bit delay element 928 and the M-bit delay element 928, in turn, applies the D_{best} value to provide delay compensation.

In block 1240, the controller 150 conducts an inquiry to determine whether Cₐᵥ is greater than C_{best}. If Cₐᵥ is greater than C_{best}, then the method 1200 follows the “Yes” branch to block 1245. Otherwise, the method 1200 follows the “No” branch the block 1250. In block 1245, the controller 150 sets C_{best} to Cₐᵥ and also sets D_{best} to the current D-value. In block 1250, the controller 150 conducts an inquiry to determine whether to continue executing the algorithm(s). In certain exemplary embodiments, this inquiry is based on the algorithm(s) being executed. For example, as illustrated in FIG. 12, the controller 150 conducts an inquiry to determine whether the least significant bit (LSB) for the M-bit delay element 928 (controlling the smallest delay element) is reached. This inquiry may be performed for FBA and BCA algorithms. In another example, the controller 150 conducts an inquiry to determine whether a predetermined number of iterations have been executed. This inquiry may be performed for an MSA algorithm. In another example, the controller 150 conducts an inquiry to determine whether a threshold step size is reached. This inquiry may be performed for a TSA algorithm.

If the LSB is reached (e.g., FBA or BCA), the predetermined number of iterations have been executed (e.g., MSA), or the threshold step size is reached (e.g., TSA), then the method 1200 follows the “YES” branch to block 1260 where the current I-value, Q-value, and D_{best} value are used to control the noise canceller 135 and the M-bit delay element 928. Otherwise, the method 1200 follows the “NO” branch to block 1255.

In block 1255, the controller 150 makes an adjustment to one or more variables and returns to block 1215 to perform another iteration of the one or more algorithms. For example, the controller 150 inverts the next lower bit in the binary D-value for FBA and BCA algorithms (most significant bit during the first iteration). In another example, if the controller 150 adds or subtracts a step in the D-value for the MSA algorithm. In other example, the controller 150 reduces the step size for the TSA algorithm, for example by reducing the step size in half.

In certain exemplary embodiments, the method 1200 may be implemented by starting with D-value at its minimum, e.g., D=(00 . . . 0) at block 1205. In block 1250 of such an embodiment, the controller 150 conducts an inquiry to see if the maximum D-value is reached, e.g. D=(1, 1, . . . , 1). In block 1255, the controller 150 increments the D-value by a predetermined value, such as one LSB. In yet another embodiment, the method 1200 may be implemented by starting with D-value at its maximum, e.g., D=(11 . . . 1) at block 1205. At block 1250, the controller 150 conducts an inquiry to see if the minimum D-value is reached, e.g., D=(00 . . . 0). In block 1255, the controller 150 decrements the D-value by a predetermined value, such as one LSB.

The exemplary methods and systems described above support improved isolation between two or more antennas, which in effect makes the antennas appear as if they are spaced further apart. This provides increased gain for a transmitter transmitting via one of the antennas while its corresponding receiver receives via another antenna. The exemplary systems and methods are agnostic with respect to the communication signal (e.g., modulation and coding) and applicable to any communication standard using same or close channel repeater. The exemplary systems and methods provide a quick response time on changing transmit signals.

Although certain exemplary embodiments have been described largely in terms of wireless repeater applications, the exemplary embodiments also can be used to isolate antennas in other applications. For example, the exemplary embodiments also can be used to improve antenna isolation between a Wi-Fi antenna and a Bluetooth antenna. Many other applications are also feasible as would be appreciated by those of ordinary skill in the art having the benefit of the present disclosure.

The exemplary methods and steps described in the embodiments presented previously are illustrative, and, in alternative embodiments, certain steps can be performed in a different order, in parallel with one another, omitted entirely, and/or combined between different exemplary embodiments, and/or certain additional steps can be performed, without departing from the scope and spirit of the invention. Accordingly, such alternative embodiments are included in the invention described herein.

The invention can be used with computer hardware and software that performs the methods and processing functions described above. As will be appreciated by those skilled in the art, the systems, methods, and procedures described herein can be embodied in a programmable computer, computer executable software, or digital circuitry. The software can be stored on computer readable media. For example, computer readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

Although specific embodiments of the invention have been described above in detail, the description is merely for purposes of illustration. It should be appreciated, therefore, that many aspects of the invention were described above by way of example only and are not intended as required or essential elements of the invention unless explicitly stated otherwise. Various modifications of, and equivalent steps corresponding to, the disclosed aspects of the exemplary embodiments, in addition to those described above, can be made by a person of ordinary skill in the art, having the benefit of the present disclosure, without departing from the spirit and scope of the invention defined in the following claim(s), the scope of which is to be accorded the broadest interpretation so as to encompass such modifications and equivalent structures.

What is claimed is:

1. A system for providing interference isolation between a first antenna and a second antenna, comprising:
an input operable to electrically couple to a signal transmission path of the first antenna to receive samples of signals for transmission by the first antenna;
an interference compensation circuit comprising:
a noise cancellation device electrically coupled to the input to receive the samples and to produce an interference compensation signal based on the samples, the interference compensation signal operable to suppress at least a portion of interference imposed on the second antenna by transmissions on the first antenna; and
a controller communicably coupled to the noise cancellation device and operable to determine an interference compensation setting for the noise cancellation device, the interference compensation setting comprising an in-phase parameter and a quadrature parameter for producing the interference compensation signal; and
an output operable to electrically couple between the noise cancellation device and a signal receiving path that connects the second antenna to a receiver, the output operable to couple the interference compensation signal to the signal receiving path.

2. The system of claim 1, wherein the noise cancellation device produces the interference compensation signal by adjusting at least one of phase, amplitude, and delay of the samples based at least on the interference compensation setting.

3. The system of claim 1, wherein the controller executes one or more computer programs to determine the interference compensation setting.

4. The system of claim 1, wherein the controller is communicably coupled to the receiver to receive a feedback value from the receiver indicating a level of interference compensation achieved by the interference compensation circuit.

5. The system of claim 1, wherein the interference compensation circuit further comprises a second noise cancellation device arranged in parallel with the noise cancellation device.

6. The system of claim 5, wherein the noise cancellation device produces the interference compensation signal for a first portion of a frequency band and the second noise cancellation device produces a second interference compensation signal for a second portion of the frequency band different than the first portion.

7. The system of claim 1, wherein the interference compensation circuit further comprises an attenuator operable to attenuate the samples.

8. The system of claim 1, wherein the interference compensation circuit further comprises an amplifier operable to amplify the interference compensation signal.

9. The system of claim 1, wherein the interference compensation circuit further comprises a power detector for measuring a power level of the samples and providing an indication of the power measurement to the controller.

10. The system of claim 9, wherein the controller adjusts the interference compensation setting for the noise canceling device based on the power measurement.

11. The system of claim 1, further comprising:
a second input electrically coupled to a signal transmission path of the second antenna to receive second samples of signals for transmission by the second antenna;
a second interference compensation circuit electrically coupled to the second input to receive the second samples and to produce a second interference compensation signal based on the second samples, the second interference compensation signal operable to suppress at least a portion of interference imposed on the first antenna by transmissions on the second antenna; and
a second output electrically coupled to a signal receiving path that connects the first antenna to a second receiver, the second output operable to couple the second interference compensation signal to the signal receiving path of the first antenna.

12. The system of claim 1, wherein the interference compensation circuit comprises a delay element for providing a time delay to the interference compensation signal such that the interference compensation signal is coupled to the signal receiving path at approximately the same time that the interference is imposed on the signal receiving path.

13. The system of claim 1, wherein the input and the second output share a coupler coupled to the signal transmission path of the first antenna and wherein the second input and the output share a coupler coupled to the signal receiving path that connects the second antenna to the receiver.

14. The system of claim 1, wherein the interference compensation circuit is implemented in one or more integrated circuits.

15. A method for isolating a first antenna from interference imposed by a second antenna, the method comprising:
obtaining at least one sample of a signal transmitted along a transmit signal path of the second antenna;
generating an interference compensation signal by adjusting at least one of amplitude, phase, and delay of the sample based on an in-phase parameter and a quadrature parameter;
applying the interference compensation signal to a receive signal path that electrically couples the first antenna to a receiver; and
in response to applying the interference compensation signal to the receive signal path, suppressing at least a portion of the interference.

16. The method of claim 15, further comprising executing a computer program to determine the in-phase parameter and the quadrature parameter.

17. The method of claim 15, further comprising attenuating the sample prior to generating the interference compensation signal.

18. The method of claim 15, wherein applying the interference compensation signal comprises applying a time delay to the interference compensation signal such that the interference compensation signal is applied to the receive signal path at approximately the same time that the interference is imposed on the receive signal path.

19. The method of claim 15, further comprising amplifying the interference compensation signal.

20. A wireless repeater, comprising:
a first antenna;
a first transmitter for transmitting signals via the first antenna;
a first receiver for receiving signals via the first antenna;
a second antenna;
a second transmitter for transmitting signals via the second antenna;
a second receiver for receiving signals via the second antenna;
a first coupling device operable to obtain samples of the signals transmitted by the second transmitter;
a second coupling device operable to couple an interference compensation signal to a receive signal path that couples the first antenna to the first receiver;
a first interference suppression device for isolating the first receiver from interference imposed on the first antenna by the signals transmitted on the second antenna, the first interference device comprising:
a first input for receiving the samples of the signals transmitted by the second transmitter;
a first interference compensation circuit operable to generate the interference compensation signal by adjusting at least one of amplitude, phase, and delay of the samples based on an in-phase parameter and a quadrature parameter, the interference compensation signal operable to suppress at least a portion of the interference imposed on the first antenna; and
a first output for passing the interference compensation signal to the second coupling device.

21. The wireless repeater of claim 20, further comprising:
a third coupling device operable to obtain second samples of the signals transmitted by the first transmitter;
a fourth coupling device operable to couple a second interference compensation signal to a second receive signal path that couples the second antenna to the second receiver;
a second interference suppression device for isolating the second receiver from interference imposed on the second antenna by the signals transmitted on the first antenna, the second interference device comprising:
a second input for receiving the second samples;
a second interference compensation circuit operable to generate the second interference compensation signal by adjusting at least one of amplitude, phase, and delay of the second samples based on a second in-phase parameter and a second quadrature parameter, the interference compensation signal operable to suppress at least a portion of the interference imposed on the second antenna; and
a second output for passing the second interference compensation signal to the fourth coupling device.

22. The wireless repeater of claim 20, wherein the first transmitter comprises an uplink transmitter and the first receiver comprises a downlink receiver.

23. The wireless repeater of claim 20, wherein the second transmitter comprises a downlink transmitter and the second receiver comprises an uplink receiver.

24. The wireless repeater of claim 20, wherein the wireless repeater is implemented in a cellular telephone network.

25. A cellular telephone network, comprising:
a base station; and
at least one wireless repeater, each wireless repeater comprising:
a first transceiver for communication signals with the base station via a first antenna;
a second transceiver for communicating signals with one or more cellular telephones via a second antenna;
a first coupling device operable to obtain samples of signals transmitted on the first antenna;
a second coupling device operable to couple an interference compensation signal to a receive signal path that couples the second antenna to the second transceiver; and
a first interference suppression device for isolating the second transceiver from interference imposed on the second antenna by the signals transmitted on the first antenna, the first interference device comprising:
a first input for receiving the samples of the signals transmitted on the first antenna;
a first interference compensation circuit operable to generate the interference compensation signal by adjusting at least one of amplitude, phase, and delay of the samples based on an in-phase parameter and a quadrature parameter, the interference compensation signal operable to suppress at least a portion of the interference imposed on the second antenna; and
a first output for passing the interference compensation signal to the second coupling device.

26. The cellular telephone network of claim 25, wherein each wireless repeater further comprises:
a third coupling device operable to obtain second samples of the signals transmitted on the second antenna;
a fourth coupling device operable to couple a second interference compensation signal to a second receive signal path that couples the first antenna to the first transceiver;
a second interference suppression device for isolating the first transceiver from interference imposed on the first antenna by the signals transmitted on the second antenna, the second interference device comprising:
a second input for receiving the second samples;
a second interference compensation circuit operable to generate the second interference compensation signal by adjusting at least one of amplitude, phase, and delay of the second samples based on a second in-phase parameter and a second quadrature parameter, the interference compensation signal operable to suppress at least a portion of the interference imposed on the first antenna; and
a second output for passing the second interference compensation signal to the fourth coupling device.
